(19) United States
(12) Patent Application Publication
(10) Pub. No.: US 2010/0044435 A1
(43) Pub. Date: Feb. 25, 2010

(54) HANDHELD SCANNING DEVICE WITH TRIPLE DATA ACQUISITION FUNCTIONALITY

(76) Inventors: Sven Ahlberg, Bozeman, MT (US); David Widder, Sparks, NV (US); Kaido Kevvai, Tallinn (EE); Gustav Poola, Tallinn (EE); Markus Kasak, Tallinn (EE); Tiit Liiv, Tallinn (EE); Anti Sullin, Tallinn (EE); Andrei Birjukov, Tallinn (EE)

Correspondence Address: ANTOINETTE M. TEASE, P. O. BOX 51016, BILLINGS, MT, 59105, US

(21) Appl. No.: 12/196,799

(22) Filed: Aug. 22, 2008

(51) Int. Cl. G06K 7/00

(52) U.S. Cl. 235/440

(57) ABSTRACT

A handheld scanning device comprising a magnetic stripe reader, a bar code reader and an RFID reader. All three of the readers are integral to the device, and none of the readers needs to be removed in order to install any of the other readers.

### BACKGROUND OF THE INVENTION

1. Field of the Invention

The present invention relates generally to the field of handheld devices, and more specifically, to a handheld scanning device that simultaneously integrates three data acquisition capabilities, namely, radio frequency identification (RFID), magnetic stripe and bar code.

2. Description of the Related Art

The three primary technologies available for effectuating Automatic Identification and Data Capture (AIDC) are RFID, magnetic stripes and bar codes. Various hardware devices exist for reading data from media that incorporates all three of these technologies, but the readers are typically confined to a single technology. In other words, three separate readers would be required to capture data from an RFID tag, a magnetic stripe and a bar code.

With magnetic stripe and bar code technologies, the amount of information that can be embedded or coded in the magnetic stripe or bar code is limited, and the readers associated with these technologies tend to be complex and expensive. Furthermore, magnetic stripe and bar code readers require a line-of-sight path to the media (i. e., the magnetic stripe or bar code) and are not always reliable. Data capture using RFID technology does not require a line-of-sight path between the RFID reader and the RFID tag and, therefore, is both more convenient and more effective at data capture.

Despite the advantages of RFID data capture over other data capture technologies, situations arise in which it would be advantageous to have the ability to use all three data capture technologies at once. Bar codes are relatively inexpensive to generate as compared to magnetic stripe cards and RFID tags. Magnetic stripes are universally used with credit cards. One could conceive of a situation where a single, handheld reader with the versatility to capture data from media incorporating all three types of technologies would be useful. For example, an exhibitor at a trade show might use such a handheld device to capture lead information as visitors wearing RFID tags come within the vicinity of the exhibitor's booth, allow visitors to pay for goods or services at the trade show using their credit cards, and keep track of inventory sold or leased at the show via bar codes. The present invention would also be useful in any situation where taking payment and tracking a package need to be accomplished simultaneously, as in, for example, a delivery service.

Prior art includes examples of single-technology readers, that is, readers that are designed to read RFID tags, magnetic stripes or bar codes. As far as the inventors are aware, however, no device exists that has the ability to capture data using all three of these technologies simultaneously—and no such device is described in any issued patent or published patent application. Examples of prior art data capture devices are discussed below.

U.S. Pat. No. 6,657,543 (Chung, 2003) discloses a system and method for tracking visitors at an exhibition. Each visitor is issued a “smart tag” with an electronic memory. Smart tag control units and antenna arrays located at exhibitor booths communicate with the smart tags and also with one or more processors that process the information stored in the electronic memory. The “smart tags” are preferably RFID tags, and smart tag readers not only read information from the RFID tags, but they also store information to the RFID tags. This patent does not deal with a reader that reads more than one type of media (RFID tag, magnetic stripe and bar code) simultaneously.

U.S. Patent Application Pub. No. 2007/0136154 (Chung) is a continuation-in-part of the '543 patent. The reader associated with this invention is shown in FIG. 3B. The device includes a single wand or other hand-holdable housing for reading the smart tag. There is no discussion of the reader having the capability of reading more than one type of media simultaneously, nor is there any provision for such capability in the physical design of the hardware itself.

U.S. Pat. No. 6,654,651 (Ashida et al., 2003) involves a system and method for providing printed matter to an attendee at an exhibition. The visitor carries an ID card with a user ID, a card reader reads the user ID information on the card, and a printer prints out information relating to the exhibition for the visitor to take with him or her. The user ID may be recorded on the ID card by magnetic recording, by printing a bar code, by punching holes, etc. RFID technology is not specifically mentioned. The patent simply states that the card reader reads information on the ID card “by a method corresponding to the ID card” and transmits that information to a server in a wired or wireless manner. The patent does not include any discussion whatsoever of a reader that can read information from more than one type of media—RFID tag, magnetic stripe and bar code—simultaneously.

U.S. Patent Application Pub. No. 20080120150 (McSheffrey et al.) deals with a system for determining a level of interest in items at a trade show based on data about the identity of the items and information indicating items in which attendees have expressed interest during the trade show (for example, the fact that an attendee visited a particular trade show booth or requested information from an exhibitor). This application contemplates that trade show visitors will wear badges with magnetic stripes and that each exhibitor booth will have a magnetic stripe reader capable of reading information on the visitor badges. The application also contemplates that visitors will carry or wear wireless handheld transceivers that allow them to collect information from selected exhibitors and grant permission for access to their contact information without directly engaging the exhibitor personnel at the booths. The handheld wireless transceivers establish wireless links with RFID tags located at the exhibitor booths; the handheld wireless transceivers act as REID tag readers, thereby conveying data associated with the exhibitor to the wireless handheld transceiver carried by the visitor. Although this application mentions magnetic stripe readers located at the booths and RFID tag readers carried by visitors, it makes no mention of a reader that simultaneously reads information encoded in magnetic stripes, RFID tags and bar codes.

U.S. Patent Application Pub. No. 20050176370 (McSheffrey et al) describes a method of data capture in which data is received in a handheld wireless transceiver from a wireless device that identifies a trade show exhibitor to a trade show attendee, a selection is received from the trade show attendee in the handheld wireless transceiver based on the exhibitor identification data, and data representing the selection is sent to a wireless mesh network repeater. In a preferred embodiment, the handheld wireless transceiver includes an RFID tag reader that captures data from RFID tags located at the exhibitor booths. The invention does not involve a reader that is capable of capturing data from more than one type of media (RFID tag, magnetic stripe and bar code) simultaneously.

U.S. Patent Application Pub. No. 20040077367 (Sama et al.) describes a system and method for wireless information retrieval regarding mobile bodies and dissemination of content based on the retrieved information. The invention entails the use of a “wireless communication sending unit” worn or attached to the mobile body (which could be a person attending a trade show). The wireless communication sending unit can be an infrared wireless communication protocol unit a radio frequency wireless communication protocol unit, or any other wireless communication protocol unit. Trade show exhibitors have wireless communication units at their booths that receive data from the wireless communication units worn by the attendees. There is no discussion in this application about the wireless communication units being able to read more than one type of media (e.g., RFID tag, magnetic stripe and bar code) simultaneously.

U.S. Patent Application Pub. No. 20030154114 (Lucarelli) discloses a system and method for capturing and manipulating tradeshow attendee information. A tradeshow attendee carries a transponder (preferably coupled to a badge or tag worn by the attendee) that stores information about the attendee. Information from the transponder can be read by readers located strategically throughout the tradeshow facility, and information can also be transmitted from the readers to the transponder. The transponders and readers communicate with each other wirelessly, and the transponder can be passive (powered by signals from an external source) or active (powered by a battery). This application does not involve a reader that can capture data from RFID tags, magnetic stripes and bar codes simultaneously.

U.S. Patent Application No. 20010041994 (Kim) provides a system and method for real-time collecting and sorting of visitor data at an exhibition. The system utilizes a visitor identification medium, which is preferably an RFID tag (called a “smart card”) and an RFID reader stationed at each booth. The reader does not simultaneously capture data from RFID tags, magnetic stripes and bar codes.

U.S. Patent Application Pub. No. 20050252976 (Dietze) does not deal with a reader per se, but it does deal with an identification badge that contains an RFID device for storing and transmitting information to an RFID reader. As stated in the Background section of the Dietze application, badges provided to visitors at trade shows for lead retrieval purposes include bar codes, magnetic stripes, RFID devices, or combinations of these three technologies. Visitor badges with bar codes are popular due to the low cost of printing the bar code on the badge. The Dietze application specifically mentions bar code readers and magnetic card readers (i. e., two separate devices) being located at an exhibitor's booth. The purpose of the invention described in this particular application is to provide a low-cost RFID badge that does not require line-of-sight access to the reader in order for data to be captured. The application does not contemplate or discuss a reader that can capture data from an RFID tag, bar code and magnetic stripe simultaneously.

Lastly, U.S. Patent Application No. 20070181664 (Hatzav et al.) discloses a system and method for acquiring identification information from a visitor at an event and producing a “smart badge” that will automatically register the visitor to the event activities. The smart badge comprises RFID, bar code and/or magnetic stripe technology to store data. The data on the smart badge is read by an “appropriate reader.” Hatzav asserts that each reader can be an individual device, or one or more of the reader technologies can be combined into a single device. No explanation is provided as to how this combination of technologies would be accomplished.

### BRIEF SUMMARY OF THE INVENTION

The present invention is a handheld scanning device comprising a magnetic stripe reader, a bar code reader and an RFID reader. In a preferred embodiment, all three of the readers are integral to the device, and none of the readers needs to be removed in order to install any of the other readers.

In a preferred embodiment, the present invention comprises a magnetic stripe reader; a bar code reader having a bar code reader PCB and a CMOS sensor; an RFID PCB having an RFID reader chip and an RFID antenna; a main PCB; a GSM/GPRS PCB; a GSM/GPRS modem; a GSM/GPRS antenna; an LCD panel; and a battery; wherein the magnetic stripe reader, bar code reader PCB, RFID PCB, GSM/GPRS PCB, LCD panel, and battery are all connected to the main PCB board. In one embodiment, the magnetic stripe reader is connected to the main PCB via a twisted harness cable; the CMOS sensor is connected to the bar code reader PCB via a flat cable; the bar code reader PCB is connected to the main PCB via a flat cable; the RFID PCB is connected to the main PCB via an inter-board connector; the GSM/GPRS PCB is connected to the main PCB via an inter-board connector; the LCD panel is connected to the main PCB via a flat cable; and the battery is connected to the main PCB via a battery power cable.

In a preferred embodiment, a foil connector provides an ultra high frequency connection between the LCD panel and the GSM/GPRS PCB. Preferably, the LCD panel comprises metal housing, and the foil connector provides resistive and capacitive connection to the metal housing of the LCD panel and capacitive connection to the GSM/GPRS PCB.

In a preferred embodiment, the present invention further comprises keypad buttons, a touch screen and a stylus. Preferably, the keypad buttons are located on the GSM/GPRS PCB.

In a preferred embodiment, the present invention further comprises a front outer casing, a rear outer casing, and an inner frame; the LCD panel and GSM/GPRS PCB are situated between the front outer casing and the inner frame; the main PCB board is situated between the inner frame and the REID PCB and battery; and the RFID PCB and battery are situated between the main PCB board and the rear outer casing. Preferably, the rear outer casing comprises a plurality of lateral ridges for ease of grip.

In a preferred embodiment, the present invention further comprises a NOR flash memory that holds boot code, operating system code and application code; a data memory card that holds configuration files and data generated by the magnetic stripe reader, bar code reader and RFID reader; and a subscriber identification module that stores a service-subscriber key used to identify a cellular network subscriber and allow the device to interoperate with a cellular network.

In a preferred embodiment, the present invention further comprises a mini USB port. Preferably, the present invention further comprises an LED light, and the mini USB port is in physical proximity to the LED light.

In a preferred embodiment, the RFID antenna comprises a partially shielding loop. In yet another preferred embodiment, the device comprises two sides, a top end and a bottom end; one side of the device comprises a recess that runs from the top end of the device to the bottom end of the device and that is for swiping magnetic stripe cards; the magnetic stripe reader reads magnetic stripe cards that are swiped from the top end of the device to the bottom end of the device; and the magnetic stripe reader reads magnetic stripe cards that are swiped from the bottom end of the device to the top end of the device.

In a preferred embodiment, the present invention further comprises a bar code reader port, the bar code reader comprises a CMOS sensor, and the bar code reader port comprises a transparent visor that shields the CMOS sensor.

In a preferred embodiment, the present invention further comprises a main PCB; the main PCB comprises eight layers; one of the layers is a ground layer, one of the layers is a power layer, and the other six layers are signal layers; and critical signals are contained in signal layers adjacent to the ground or power layer. In one embodiment, the critical signals are an SDRAM clock and a USB signal.

In a preferred embodiment, the present invention further comprises embedded software that allows data to be scanned and stored for real-time and/or future use.

### BRIEF DESCRIPTION OF THE DRAWINGS

FIG. 1 is a perspective view of the present invention.

FIG. 2 is front view of the present invention.

FIG. 3 is a first side view of the present invention.

FIG. 4 is a second side view of the present invention.

FIG. 5 is a top view of the present invention.

FIG. 6 is a bottom view of the present invention.

FIG. 7 is a rear view of the present invention.

FIG. 8 is rear view of the present invention with the rear outer casing removed.

FIG. 9 is a rear view of the present invention with the rear outer casing and battery removed.

FIG. 10 is a rear view of the present invention with the rear outer casing, battery and RFID PCB removed.

FIG. 11 is a front view of the present invention with the front outer casing removed.

FIG. 11A is a front view of the present invention with the front outer casing removed and the LCD panel lifted to show the foil connector.

FIG. 11B is a front view of the present invention with the front outer casing, LCD panel and GSM/GPRS PCB removed.

FIG. 12 is a section view of the layers of the main PCB of the present invention.

FIG. 13 is a flow diagram that illustrates the operation of the present invention.

FIG. 14 is a first screen shot of the present invention.

FIG. 15 is a second screen shot of the present invention.

FIG. 16 is a third screen shot of the present invention.

FIG. 17 is a fourth screen shot of the present invention.

FIG. 18 is a fifth screen shot of the present invention.

### REFERENCE NUMBERS

1 Front outer casing

2 Touch screen

3 Keypad buttons

4 Stylus

5 Channel (for stylus)

6 Magnetic stripe reader

7 Recess (for magnetic stripe cards)

8 LED light

9 Bar code reader port

10 Bar code reader

11 Mini USB port

12 Rear outer casing

13 Inner frame

14 Lateral ridge (on rear outer casing)

15 Screw

16 Battery

17 RFID PCB

18 RFID antenna

19 RFID reader chip

20 Main PCB

21 Partially shielding loop

22 Battery power cable

23 Inter-board connector

24 Data memory card

25 Socket

26 Flat cable

27 Bar code reader PCB

28 Flat cable

29 LCD panel

30 Subscriber identification module

31 Twisted cable harness

32 CMOS sensor

33 Transparent visor

34 Flat cable

35 GSM/GPRS PCB

36 Foil connector

37 Inter-board connector

38 Speaker

39 NOR flash memory

### DETAILED DESCRIPTION OF INVENTION

The present invention is a handheld device that has the ability to capture data from RFID tags, magnetic stripes and bar codes simultaneously. Specifically, the device scans data from various types of media and stores the acquired data internally. In addition, due to the space-saving configuration inside of the device and the precautions that have been taken in the design of the device to prevent interference between the various readers, the device is smaller than any other handheld REID, magnetic stripe or bar code scanner on the market.

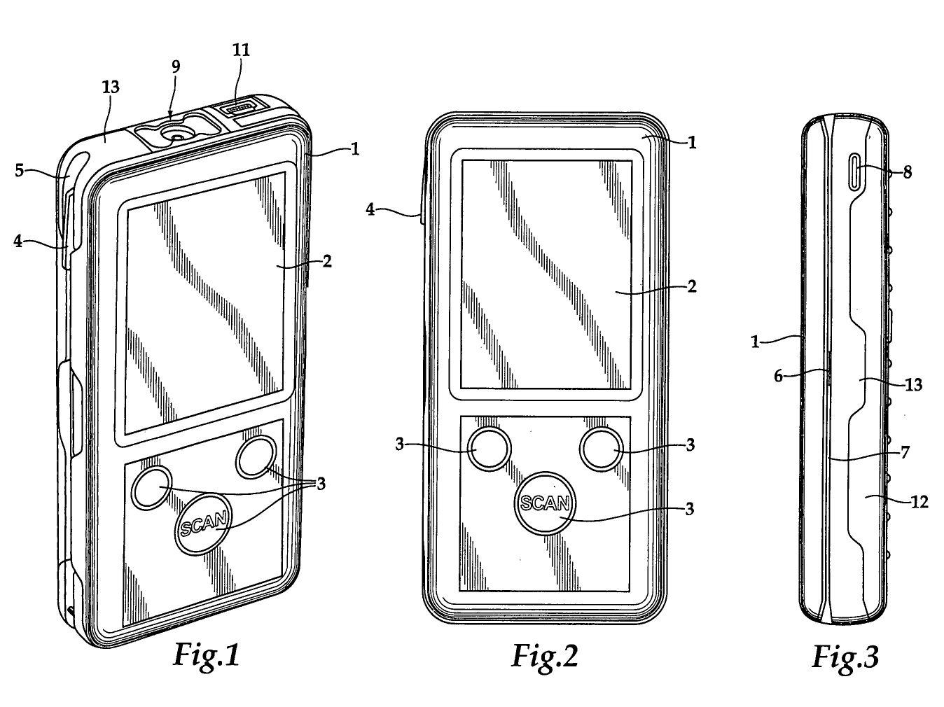

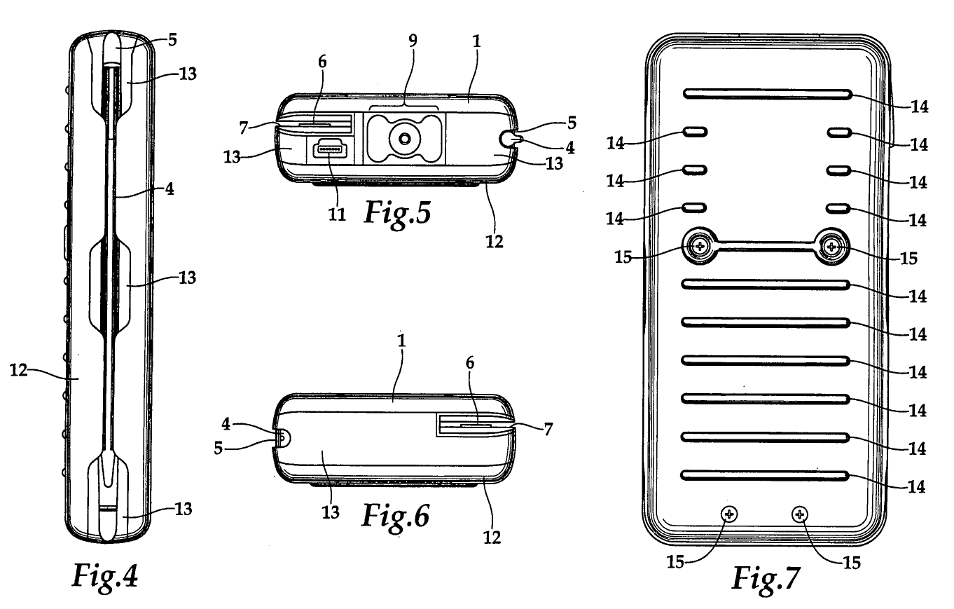

FIG. 1 is a perspective view of the present invention. As shown in this figure, the device comprises a front outer casing 1, a touch screen 2, keypad buttons 3 and a stylus 4 that rests inside of a channel 5 on the side of the device (see FIG. 4).

FIG. 2 is front view of the present invention. In a preferred embodiment, the device is approximately 2½ inches wide, 5¼ inches high, and one inch wide. Thus, as shown in FIGS. 3 and 4, the device has a slim profile.

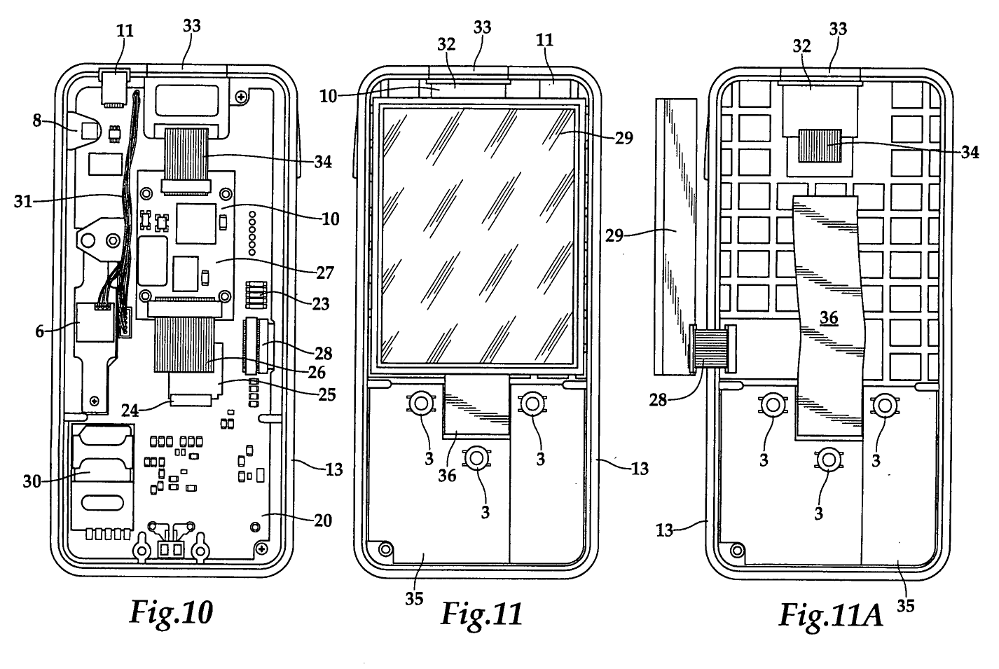

FIG. 3 is a first side view of the present invention. This view shows the side of the device that incorporates the magnetic stripe reader 6. The magnetic stripe reader 6 is located inside of the device (see FIG. 10), but the recess 7 for swiping credit cards or other cards with magnetic stripes is located on the side of the device, as shown in FIG. 3. This recess 7 is in physical proximity to the magnetic stripe reader 6. This side of the device also incorporates an LED light 8 that signals when the battery 16 is being charged and/or when it is fully charged.

FIG. 4 is a second side view of the present invention. This view shows the side of the device that holds the stylus 4. The stylus 4 can be used to make selections on the touch screen 2, as can the user's finger.

FIG. 5 is a top view of the present invention. This view shows the bar code reader port 9, which is in physical proximity to the bar code reader 10 located inside of the device (see FIG. 10). (As used herein, the term “bar code reader” means the bar code reader PCB 27 and the CMOS sensor 32.) This view also shows the mini USB port 11, which allows data to be uploaded from the device to a computer. The LED light 8, which indicates when the device is being charged, is preferably in physical proximity to the mini USB port 11. The recess 7 for swiping magnetic stripe cards is visible in this figure, as is the channel 5 for holding the stylus 4. This figure also shows the rear outer casing 12.

FIG. 6 is a bottom view of the present invention. This figure shows the front outer casing 1, the stylus 4 and channel 5 for the stylus, the magnetic stripe reader 6, and the recess 7 for swiping magnetic stripe cards. It also shows the rear outer casing 12. The inner frame 13 is shown in this figure, as well as FIGS. 1, 3, 4 and 5.

FIG. 7 is a rear view of the present invention. This figure shows the rear outer casing 12, which preferably comprises a plurality of lateral ridges 14 for ease of grip. The rear outer casing 12 is preferably secured to the inner frame 13 with screws 15.

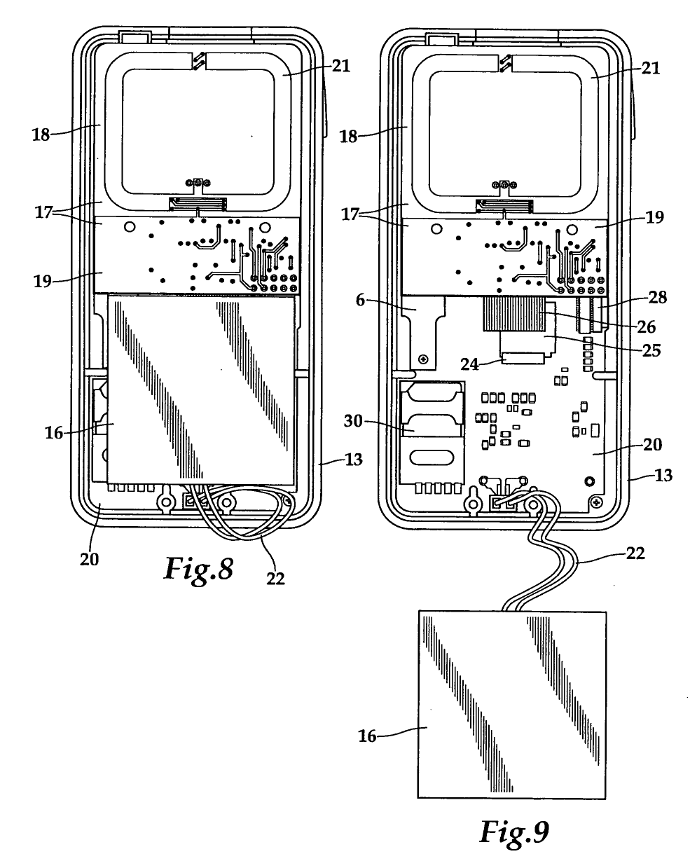

FIG. 8 is rear view of the present invention with the rear outer casing 12 removed. As shown in this figure, the invention comprises a battery 16 and an RFID PCB 17. The RFID printed circuit board (PCB) comprises an RFID antenna 18 and a reader chip 19. In a preferred embodiment, the RFID reader employs 13.56 Mhz technology and is capable of capturing data from ISO15693, ISO4443A and ISO14443B tags. (As used herein, the term “RFID reader” means the RFID PCB, including the RFID antenna and the REID reader chip.) In a preferred embodiment, the antenna comprises a partially shielding loop 21, which reduces electromagnetic compatibility (EMC) emissions and prevents interference with the signals of the main PCB 20. In a preferred embodiment, the RFID reader chip 19 is an NXP RC632 contactless reader integrated chip. Both the battery 16 and the RFID PCB 17 are physically connected to the main PCB 20.

FIG. 9 is a rear view of the present invention with the rear outer casing 12 and battery 16 removed. The battery 16 is connected to the main PCB 20 via a battery power cable 22. The REID PCB 17 is connected to the main PCB 20 via an inter-board connector 23 (see FIG. 10). This figure shows the data memory card 24, which fits into a socket 25 on the main PCB 20. The data memory card 24 is preferably a microSD card with at least 32 megabyte capacity. The data memory card 24 holds the data generated by the AIDC devices (i.e., the RFID, magnetic stripe and bar code readers) as well as the configuration files.

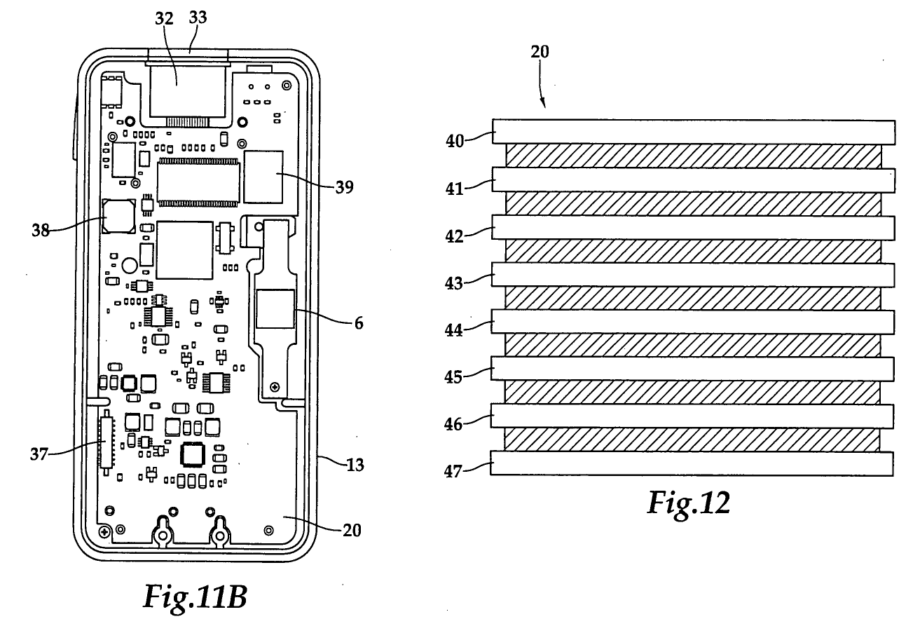

The magnetic stripe reader 6 is partially shown in FIG. 9, as is the flat cable 26 that connects the bar code reader PCB 27 (see FIG. 10) to the main PCB 20. FIG. 9 also shows the flat cable 28 that connects the LCD panel 29 (see FIG. 11) to the main PCB 20.

The present invention further comprises a subscriber identification module 30, which is also shown in FIG. 9. The subscriber identification module 30 is a removable smart card integrated circuit card (ICC) that securely stores the service-subscriber key used to identify a subscriber. The subscriber identification module 30 is required by the GSM/GPRS modem to identify the cellular network subscriber and interoperate with the cellular network.

FIG. 10 is a rear view of the present invention with the rear outer casing 12, battery 16 and RFID PCB 17 removed. This figure shows the magnetic stripe reader 6, which is connected to the main PCB 20 via a twisted cable harness 31. In a preferred embodiment, the magnetic stripe reader 6 is capable of capturing data from up to three tracks of most ISO-7811 compatible magnetic stripe cards. The magnetic stripe reader 6 supports card swipes in both directions to simplify operation in portable applications.

Also shown in FIG. 10 is the bar code reader 10, which comprises a bar code reader PCB 27 and a complementary metal-oxide-semiconductor (CMOS) sensor 32 (see FIG. 11A). The CMOS sensor 32 is covered by a transparent visor 33. In a preferred embodiment, the CMOS sensor is an OPTICON® MDI-1000 CMOS imaging module. A flat cable 34 connects the CMOS sensor 32 to the bar code reader PCB 27, and another flat cable 26 connects the bar code reader PCB 27 to the main PCB 20. In a preferred embodiment, the bar code reader employs a 1.3 megapixel grayscale sensor equipped with a wide-angle lens and includes red illumination LED lights and green targeting LED lights. The bar code reader is capable of capturing and decoding most common linear and two-dimensional bar codes, including, but not limited to, PDF417.

The mini USB port 11 and LED light 8 are also shown in FIG. 10.

FIG. 11 is a front view of the present invention with the front outer casing 1 removed. As shown in this figure, the present invention comprises an LCD panel 29 and a Global System for Mobile Communications (GSM)/General Packet Radio Service (GPRS) PCB 35 with a GSM/GPRS modem (not shown) for real-time data upload. This functionality enables the device to send captured data to a remote server for immediate online access. In a preferred embodiment, the GSM/MPRS modem is a TELIT® GE864-QUAD module with an integrated TYCO® board antenna (not shown). (The GSM/GPRS modem and antenna are on the back of the GSM/GPRS PCB.) The GSM/GPRS PCB 35 preferably comprises key pad buttons 3, which are also shown in FIGS. 1 and 2. The LCD panel 29 provides the display for the touch screen 2.

In a preferred embodiment, the present invention further comprises a foil connector 36 that provides an ultra high frequency (UHF) connection between the LCD panel 29 and the GSM/GPRS PCB 35. The foil connector 36 provides resistive and capacitive connection to the metal housing of the LCD panel 29 and capacitive connection to the GSM/GPRS PCB 35 ground polygon. This connection reduces emissions and also improves the GSM/GPRS antenna gain. FIG. 11A is a front view of the present invention with the front outer casing 1 removed and the LCD panel 29 lifted to show the foil connector 36.

Tables 1 and 2 below illustrate one example of the emissions reduction achieved by adding the foil connector 36 to the present invention:

TABLE 1
WITHOUT COPPER FOIL

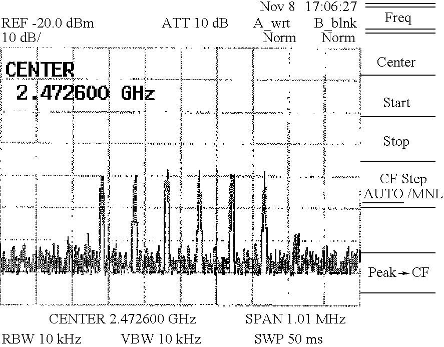

TABLE 2
WITH COPPER FOIL

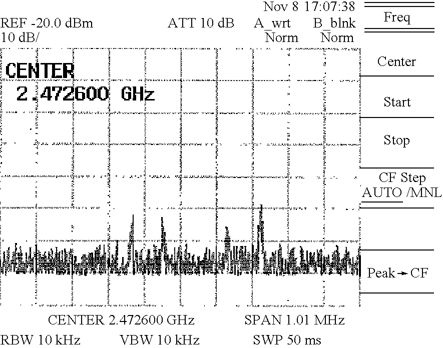

Each vertical block on the above two graphs represents ten decibels (10 dB). As illustrated in these two graphs, the addition of the foil connector 36 reduced emissions by approximately 10 dB.

FIG. 11B is a front view of the present invention with the front outer casing 1, LCD panel 29 and GSM/GPRS PCB 3 5 removed. This figure shows the magnetic stripe reader 6 and the CMOS sensor 32. It also shows the inter-board connector 37 that connects the GSM/GPRS PCB 35 to the main PCB 20.

The present invention preferably comprises a speaker 38, which generates a beep when a badge is scanned, when certain buttons are pressed on the touch screen 2, etc. The present invention further comprises a NOR flash memory 39, which holds the boot code, the operating system code, and the application code.

FIG. 12 is a section view of the layers of the main PCB 20 of the present invention. In a preferred embodiment, the main PCB comprises eight layers, two of which are so-called “reference” planes. The reference planes are ground or power planes. Generally speaking, it is preferable to situate critical signals in signal layers directly adjacent to a reference plane.

The first layer 40 is preferably a signal layer, and this layer preferably comprises the USB signal. The second layer 41 is preferably a ground plane. Although the ground plane could be part of a signal layer, the present invention utilizes a single, solid ground plane (layer) to reduce emissions. The third 42, fourth 43, fifth 44 and sixth 45 layers are also signal layers, and the sixth layer 45 preferably comprises the SDRAM clock signal.

The seventh layer 46 is the power plane. In a preferred embodiment, the power plane is a continuous power plane carrying VCC3V3 rail. The eighth layer 47 is also a signal layer.

In this configuration, continuous power and ground planes are situated adjacent to critical signal layers in order to improve stability and immunity to electromagnetic interferences, as well as to cut EMC emissions. The most critical signals are the SDRAM clock and the USB signals. These are routed next to continuous planes and have controlled impedance in order not to cause excessive radiation and maintain integrity. Impedance is controlled through trace thickness and distance to the reference (ground or power) plane.

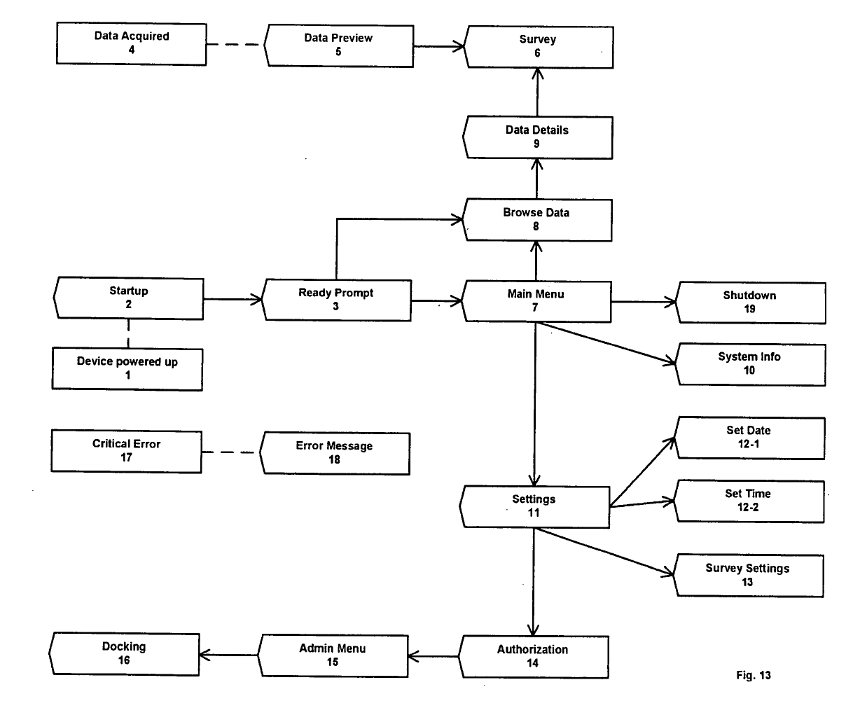

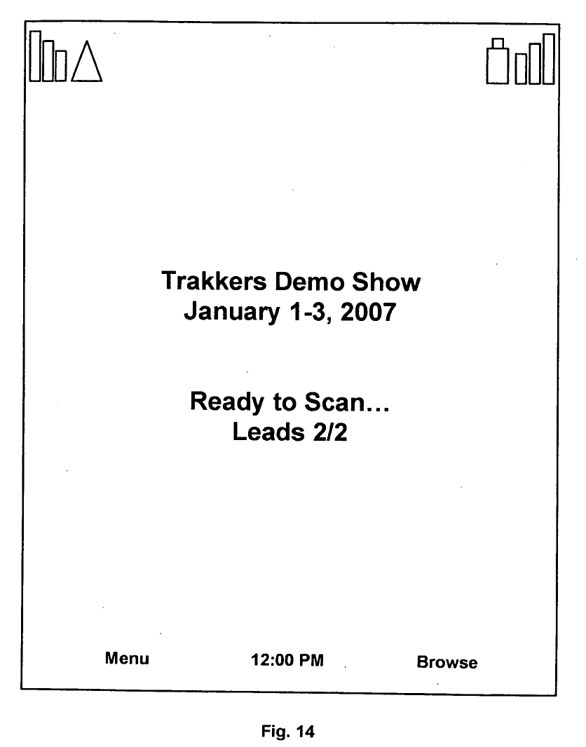

In a preferred embodiment, the present invention comprises embedded software that allows data to be scanned and stored for real-time or future use. FIG. 13 is a flow diagram that illustrates the operation of the present invention. FIGS. 14-18 provide examples of user interfaces for the embedded software; however, the present invention is not limited to any particular type or configuration of user interface.

Upon device startup (FIG. 13, block 1), the machine will display a splash screen (FIG. 13, block 2) that can be customized to display a logo or any desired graphic. Upon completion of start-up, the user is presented with a Ready Prompt (FIG. 13, block 3). This is the main application screen and displays customizable default information, as well as a count of data items captured. For example, in a tradeshow lead capture application, the user will be presented with the show name, show dates, and number of leads captured (see FIG. 14).

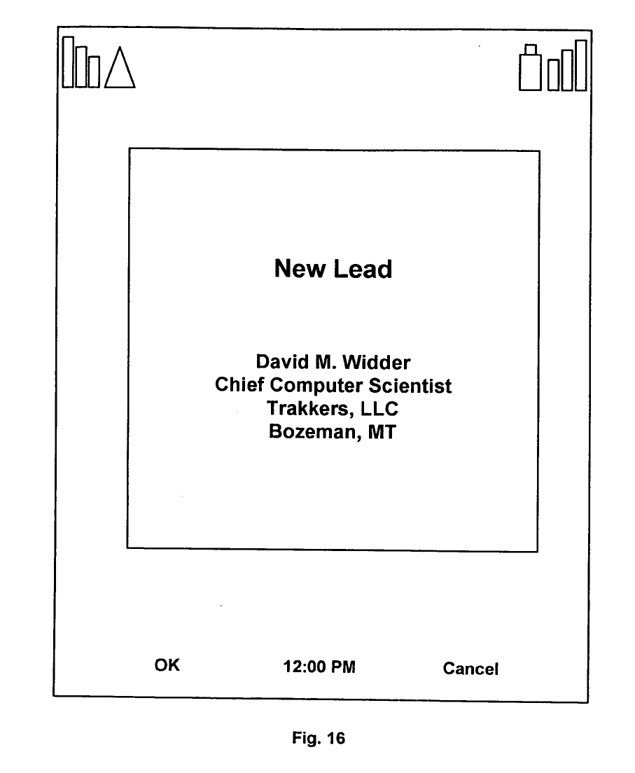

At the Ready Prompt, the present invention is ready to capture data by any of the enabled AIDC input devices. On detection of a data capture event (FIG. 13, block 4), the user is presented with a Data Preview screen (FIG. 13, block 5), which displays certain of the captured data to the user based on predefined configuration settings. In a tradeshow lead capture application, the Data Preview screen could display the name, title, and company of the attendee based on information read from the attendee badge (see FIG. 16).

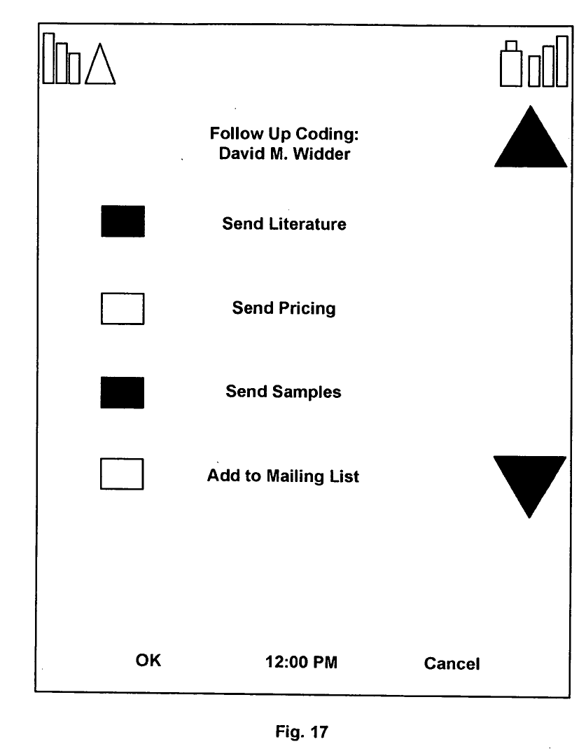

If enabled, the user will be able to further detail the scanned data by means of the survey screens (FIG. 13, block 6). The survey screens are configurable and provide customized data qualification options. For example, in a tradeshow lead capture application, these options might include sending literature, pricing and samples to the attendee and adding the attendee to the exhibitor's mailing list (see FIG. 17).

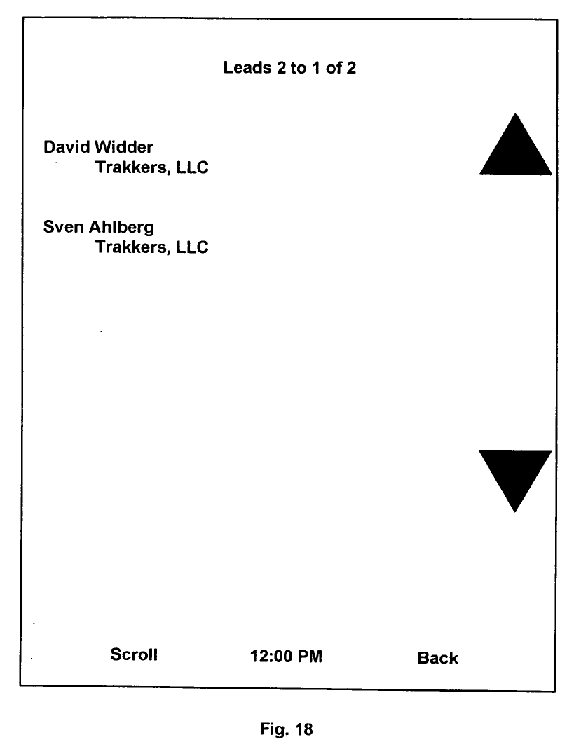

From the Ready Prompt, the user can Browse Data stored on the present invention (FIG. 13, block 8). This data is preferably displayed in a scrollable list (see FIG. 18) where the user can view details of the data (FIG. 13, block 9) as well as re-qualify the data with the same survey information (FIG. 13, block 6) available upon data capture.

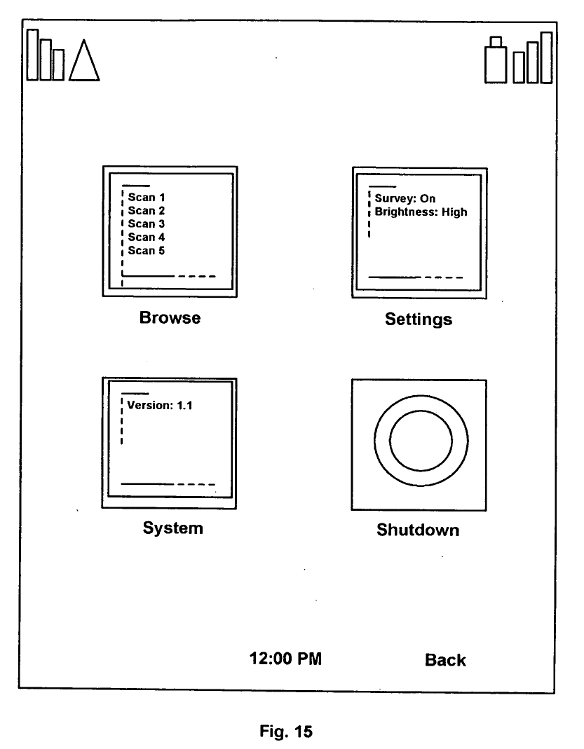

From the Ready Prompt, the user can also navigate to the Main Menu (FIG. 13, block 7). From the Main Menu (see FIG. 15), the user can Browse Data, view System Information, control device Settings, and Shutdown (FIG. 13, block 19) the device.

Selecting “System Information” (FIG. 13, block 10) will display software version, serial number, GSM/GPRS network status, and battery status.

Selecting Settings (FIG. 13, block 11) from the Main Menu will allow the user to customize device settings, such as local Date and Time (FIG. 13, blocks 12-1 and 12-2), LCD screen brightness, as well as Survey Settings (FIG. 13, block 13). At the Survey Setting screen, the user can control which survey questions are enabled and queried after a data capture event (FIG. 13, block 6).

Administrative settings and functions are also accessible from the Settings screen (FIG. 13, block 11). Upon selecting Administrative Menu from the Settings screen, the user will be prompted with an Authorization screen (FIG. 13, block 14). Upon successful entering of a PIN, the Administrative Menu (FIG. 13, block 15) will be displayed. This is where the administrator can perform such functions as Backup Leads, Erase Leads, Reset User Settings to default, and dock the unit to a PC via the USB port (FIG. 13, block 16).

If at any time during operation, an error is detected (FIG. 13, block 17), the user will be presented with an Error Message screen (FIG. 13, block 18). If the error is a hard error (such as a missing configuration, out of disk space, etc.), then the unit will display the message for a certain period of time and power itself down, preventing data collection. If the error is a soft error (like an invalid or improperly formatted scan), then the unit will display the error message and resume operation.

Although the above examples deal with data capture occurring at trade shows, the present invention is not limited to any particular application or industry. It can be used in any situation in which the user has a need to capture data using RFID, magnetic stripe and/or bar code technology.

The preferred embodiment of the present invention has been shown and described; however, it will be apparent to those skilled in the art that many changes and modifications may be made without departing from the invention in its broader aspects. The appended claims are therefore intended to cover all such changes and modifications as fall within the true spirit and scope of the invention.

We claim:

1. A handheld scanning device comprising a magnetic stripe reader, a bar code reader and an RFID reader.

2. The handheld scanning device of claim 1, wherein all three of the readers are integral to the device, and none of the readers needs to be removed in order to install any of the other readers.

3. A handheld scanning device comprising:
(a) a magnetic stripe reader;
(b) a bar code reader having a bar code reader PCB and a CMOS sensor;
(c) an RFID PCB having an RFID reader chip and an RFID antenna;
(d) a main PCB;
(e) a GSM/GPRS PCB;
(f) a GSM/GPRS modem;
(g) a GSM/GPRS antenna;
(h) an LCD panel; and
(i) a battery;
wherein the magnetic stripe reader, bar code reader PCB, RFID PCB, GSM/GPRS PCB, LCD panel, and battery are all connected to the main PCB board.

4. The handheld scanning device of claim 3, wherein the magnetic stripe reader is connected to the main PCB via a twisted harness cable;
wherein the CMOS sensor is connected to the bar code reader PCB via a flat cable;
wherein the bar code reader PCB is connected to the main PCB via a flat cable;
wherein the RFID PCB is connected to the main PCB via an inter-board connector;
wherein the GSM/GPRS PCB is connected to the main PCB via an inter-board connector;
wherein the LCD panel is connected to the main PCB via, a flat cable; and
wherein the battery is connected to the main PCB via a battery power cable.

5. The handheld scanning device of claim 3, wherein a foil connector provides an ultra high frequency connection between the LCD panel and the GSM/GPRS PCB.

6. The handheld scanning device of claim 5, wherein the LCD panel comprises metal housing, and wherein the foil connector provides resistive and capacitive connection to the metal housing of the LCD panel and capacitive connection to the GSM/GPRS PCB.

7. The handheld scanning device of claim 1, miter comprising keypad buttons, a touch screen and a stylus.

8. The handheld scanning device of claim 3, further comprising keypad buttons, a touch screen and a stylus.

9. The handheld scanning device of claim 8, wherein the keypad buttons are located on the GSM/GPRS PCB.

10. The handheld scanning device of claim 1 or 3, further comprising a front outer casing, a rear outer casing, and an inner frame;
wherein the LCD panel and GSM/GPRS PCB are situated between the front outer casing and the inner frame;
wherein the main PCB board is situated between the inner frame and the RFID PCB and battery; and
wherein the RFID PCB and battery are situated between the main PCB board and the rear outer casing.

11. The handheld scanning device of claim 10, wherein the rear outer casing comprises a plurality of lateral ridges for ease of grip.

12. The handheld scanning device of claim 1, further comprising:
a NOR flash memory that holds boot code, operating system code and application code;
a data memory card that holds configuration files and data generated by the magnetic stripe reader, bar code reader and RFID reader; and
a subscriber identification module that stores a service-subscriber key used to identify a cellular network subscriber and allow the device to interoperate with a cellular network.

13. The handheld scanning device of claim 3, further comprising:
(j) a NOR flash memory that holds boot code, operating system code and application code;
(k) a data memory card that holds configuration files and data generated by the magnetic stripe reader, bar code reader and RFID reader; and
(l) a subscriber identification module that stores a service-subscriber key used to identify a cellular network subscriber and allow the device to interoperate with a cellular network.

14. The handheld scanning device of claim 1 or 3, further comprising a mini USB port.

15. The handheld scanning device of claim 14, further comprising an LED light, wherein the mini USB port is in physical proximity to the LED light.

16. The handheld scanning device of claim 3, wherein the RFID antenna comprises a partially shielding loop.

17. The handheld scanning device of claim 1 or 3, wherein the device comprises two sides, a top end and a bottom end;
wherein one side of the device comprises a recess that runs from the top end of the device to the bottom end of the device and that is for swiping magnetic stripe cards;
wherein the magnetic stripe reader reads magnetic stripe cards that are swiped from the top end of the device to the bottom end of the device; and
wherein the magnetic stripe reader reads magnetic stripe cards that are swiped from the bottom end of the device to the top end of the device.

18. The handheld device of claim 1, further comprising a bar code reader port;
wherein the bar code reader comprises a CMOS sensor; and
wherein the bar code reader port comprises a transparent visor that shields the CMOS sensor.

19. The handheld device of claim 3, further comprising a bar code reader port;
wherein the bar code reader port comprises a transparent visor that shields the CMOS sensor.

20. The handheld device of claim 1, further comprising a main PCB;
wherein the main PCB comprises eight layers;
wherein one of the layers is a ground layer, one of the layers is a power layer, and the other six layers are signal layers; and
wherein critical signals are contained in signal layers adjacent to the ground or power layer.

21. The handheld scanning device of claim 3, wherein the main PCB comprises eight layers;
wherein one of the layers is a ground layer, one of the layers is a power layer, and the other six layers are signal layers; and
wherein critical signals are contained in signal layers adjacent to the ground or power layer.

22. The handheld scanning device of claim 20 or 21, wherein the critical signals are an SDRAM clock and a USB signal.

23. The handheld scanning device of claim 1 or 3, further comprising embedded software that allows data to be scanned and stored for real-time and/or future use.
